(19) United States
(12) Patent Application Publication
(10) Pub. No.: US 2017/0024011 A1
(43) Pub. Date: Jan. 26, 2017

(54) CONTROL DEVICE FOR A MOTOR VEHICLE AND CONTROL METHOD

(71) Applicant: DAV, Créteil (FR)

(72) Inventors: Stéphanie DABIC, Creteil (FR); Jean-Marc TISSCOT, Creteil (FR)

(73) Assignee: DAV, Créteil (FR)

(21) Appl. No.: 15/104,340

(22) PCT Filed: Dec. 18, 2014
(86) PCT No.: PCT/FR2014/000288

§ 371 Date: Jun. 14, 2016

(30) Foreign Application Priority Data
Dec. 19, 2013 (FR) 1303010

(51) Int. Cl. G06F 3/01; G06F 3/041; B60Q 9/00

(52) U.S. Cl. CPC G06F 3/016; B60Q 9/00; G06F 3/0416; G06F 3/0414; G06F 3/045

(57) ABSTRACT

The present invention relates to a new process for the synthesis of Colesevelam, which is used in therapy in cases of hypercholesterolemia due to low density lipoproteins. Said process comprises the reaction, in a basic environment, of polyallylamine with: i) at least one alkylating agent of formula X—(CH₂)₉—CH₃ and at least one alkylating agent of formula Y—(CH₂)₆—N⁺ (CH₃)₃Z⁻, wherein X and Y are each independently a leaving group, and Z is a halogen; and ii) at least one crosslinking agent. The present invention also relates to the Colesevelam obtainable by the above process.

The present invention relates to a control device for a motor vehicle and a method for controlling said control device.

In recent years, automobiles have become more easy to manipulate with the appearance of new emerging technologies (for example power steering, ABS, cruise control, rear parking aid, etc.). Paradoxically, however, the number of functions to be controlled during driving has itself also increased greatly. This may result in a certain complexity linked to poor knowledge of the use of these functionalities and to their diversity. The automobile has become a true living space, perceived as a personal and interconnected communication center, with, for example, the MP3 player, GPS, connection to mobile telephones.

The introduction of these new functions manifests itself in an increase in the number of buttons on the dashboard of an automobile cockpit. However, the number of buttons cannot be increased indefinitely, notably due to the resulting complexity, limited space, accessibility or cognitive load. Moreover, the interaction of the driver with the on-board systems in the automobile can reproduce a situation of attention overload in which the driver cannot optimally process all the information of the driving task, manifesting itself in errors and a long detection time.

One possibility is to centralize the buttons by replacing them with a touchscreen. This allows the number of functions to continue to be increased, said functions becoming programmable and reconfigurable and exposed temporarily or permanently according to the context of the activated function. The screen thus includes a multi-functionality facility, while virtualizing the buttons and being customizable. Moreover, the screens have three other major advantages: on the one hand, they allow a direct interaction (the co-location of the display and input), on the other hand, they are flexible (the display can easily be configured for a certain number of functions), and finally they are intuitive (familiar interaction method such as, for example, “pointing”).

However, in contrast to the case of a push-button, when the driver interacts with a touchscreen he receives no feedback linked directly to his action on the interface, other than the simple contact of his finger pressing on the screen.

In order to compensate for the loss of information caused by the substitution of conventional mechanical interfaces with touchscreens, it is provided to add feedback, such as haptic feedback, in order to provide a response from the system to the user. This feedback avoids the possible ambiguity of taking account of the action of the user by the system, likely to encourage the appearance of dangerous situations. However, it must also avoid overloading the visual and auditory pathways already involved in the driving task. In fact, the use of touchscreens in a motor vehicle must not distract the attention of the driver.

One object of the present invention is to provide a control device and a method for controlling said control device which does not interfere with driving, which is well perceived and appreciated by users, and which can be discriminable from the other signals for a touchscreen application adhering to automobile constraints.

For this purpose, the subject-matter of the present invention is a control device for a motor vehicle comprising a touch-sensitive surface and a haptic feedback module configured to cause the touch-sensitive surface to vibrate in response to a contact with the touch-sensitive surface, characterized in that the generated vibration of the touch-sensitive surface is obtained by movements of the touch-sensitive surface having an amount of between 5 and 110 μm with an acceleration of the movement of the touch-sensitive surface of between 2*G and 8*G.

The inventors have in fact discovered that, for automobile driving, haptic feedback is better perceived by the user if the sensation is close to that of a manipulation of a conventional push-button. Since the manipulation of a conventional push-button requires a depression generally in the region of more than one millimeter, the inventors have noted that by controlling, on the one hand, the acceleration values of the touch-sensitive surface and, on the other hand, the amounts of the movement of the touch-sensitive surface, the sensed vibration gave the illusion of the manipulation of the physical button. It is in fact the modification of these two physical parameters of the vibratory feedback, between 5 and 100 μm, for the movements of the touch-sensitive surface, and between 2*G and 8*G for the acceleration of the movement of the touch-sensitive surface which are the most relevant for affecting the sensation of users, allowing the vibratory feedback to be perceived as a button and thus to be better discriminated by the user, avoiding his distraction while driving.

According to one example embodiment, the haptic feedback module is configured to generate amounts of movements of the touch-sensitive surface:
of between 5 and 38 μm for an acceleration of the movement of the touch-sensitive surface of between 4.5*G and 8*G, and/or
of between 54 and 110 μm for an acceleration of the movement of the touch-sensitive surfaces of between 2*G and 4.5*G.

It is in fact noted that, in order to approximate the “push-button sensation”, it is preferable for the acceleration to increase with the increase in the amount of movement for small movements (less than 38 μm). For movements having a greater amount, beyond 54 μm, the acceleration is also increased with the increase in the movement, but at lower values than for small movements.

The duration of the vibration of the touch-sensitive surface is, for example, less than 200 ms.

The frequency of the vibration of the touch-sensitive surface is, for example, between 60 and 200 Hz.

The subject-matter of the invention is also a method for controlling a control device for a motor vehicle as previously described, characterized in that the touch-sensitive surface is caused to vibrate in response to a contact with the touch-sensitive surface by moving the touch-sensitive surface by an amount of between 5 and 110 μm with an acceleration of the movement of the touch-sensitive surface of between 2*G and 8*G.

According to one example embodiment, amounts of movements of the touch-sensitive surface are generated:
of between 5 and 38 μm for an acceleration of the movement of the touch-sensitive surface of between 4.5*G and 8*G, and/or
of between 54 and 110 μm for an acceleration of the movement of the touch-sensitive surface of between 2*G and 4.5*G.

According to one embodiment, the amount of movement of the touch-sensitive surface and the acceleration of the movement of the touch-sensitive surface have interdependent values.

For example, the increase in the value of the amount of movement of the touch-sensitive surface is approximately proportional to the increase in the value of the acceleration of the movement of the touch-sensitive surface.

### SUMMARY DESCRIPTION OF THE DRAWINGS

Other advantages and characteristics will become evident from a reading of the description of the invention, and also from the attached figures, which show a non-limiting example embodiment of the invention, and in which:

FIG. 1 shows an example of a control device for an automobile, and
FIG. 2 shows the acceleration values of the touch-sensitive surface as a number of G, as a function of the values of movements in μm of the touch-sensitive surface.

In these figures, identical elements bear the same reference numbers.

### DETAILED DESCRIPTION

FIG. 1 shows a control device for a motor vehicle 1, for example disposed in a control panel of the vehicle.

The control device 1 comprises a touch-sensitive surface 2 and a haptic feedback module 4 configured to cause the touch-sensitive surface 2 to vibrate in response to a contact with the touch-sensitive surface by a finger or any other activation means (for example a stylus) of the user having, for example, modified or selected a control.

The term “haptic” refers to feedback by touching. Thus, haptic feedback is a vibratory or vibrotactile signal.

The touch-sensitive surface 2 is, for example, that of a touchscreen. A touchscreen is a peripheral input device allowing users of the system to interact with said system by touch. It allows direct interaction of the user on the area that he wishes to select for various uses such as, for example, selection of a destination address or name in a directory, adjustments of the air conditioning system, activation of a dedicated function, selection of a track from a list, or generally browsing through a list of choices, selection, validation and error.

The touch-sensitive surface 2 comprises a plate carrying a contact sensor to detect a contact pressure or a movement of the finger or of a stylus of the user.

The contact sensor is, for example, a pressure sensor, such as that using FSR (“Force Sensing Resistor”) technology, i.e. using pressure-sensitive resistors. FSR technology has a very good resistance and robustness, while having a high resolution. Furthermore, it is highly reactive and precise, while being relatively stable over time. It may have a quite long service life, and is usable with any type of activation means, at a relatively low cost.

According to one design of FSR technology, the sensor operates by establishing contact between two conductive layers, for example through the action of the finger. One of the implementations consists in covering a glass plate with a layer of conductive ink on which a flexible polyester sheet is superimposed, itself covered on its internal surface by a layer of conductive ink. Isolating and transparent studs isolate the plate from the polyester sheet. The activation on the touch-sensitive surface produces a slight depression of the polyester layer which comes into contact with the conductive layer of the glass plate. The local contact of the two conductive layers causes a modification of the electric current applied to the plate, corresponding to a voltage gradient.

According to a different example, a contact sensor includes flexible semi-conductive layers sandwiched between, for example, a conductive layer and a resistive layer. By applying a pressure or a slide to the FSR layer, its ohmic resistance decreases, thus allowing the applied pressure and/or the localization of the place where the pressure is applied to be measured through application of an adapted electric voltage.

According to a different example, the contact sensor is based on capacitive technology.

The haptic feedback module 4 comprises at least one actuator 3 connected to the plate of the touch-sensitive surface 2 in order to generate the haptic feedback as a function of a signal originating from the contact sensor. The haptic feedback is a vibratory signal such as a vibration produced by a sinusoidal control signal or by a control signal comprising one pulse or a succession of pulses sent to the actuator 3. The vibration is, for example, directed in the plane of the touch-sensitive surface 2 or orthogonally to the plane of the touch-sensitive surface 2 or is directed according to a combination of these two directions.

In the case of a plurality of actuators, said actuators are disposed under the touch-sensitive surface 2 in different positions (in the center or on one side) or in different orientations (in the direction of the pressing on the surface or in a different axis).

According to one example embodiment, the actuator 3 is based on a technology similar to loudspeaker or “Voice Coil” technology. It comprises a fixed part and a part that is displaceable in a gap of the fixed part, for example in the region of 200 μm, between a first and a second position, parallel to a longitudinal axis of the movable part. The movable part is, for example, formed by a movable magnet sliding inside a fixed coil or by a movable coil sliding around a fixed magnet, the movable part and the fixed part interworking due to an electromagnetic effect. The movable parts are connected to the plate in such a way that the movement of the movable parts causes the displacement of the plate in order to generate the haptic feedback to the finger of the user. This technology is easily controllable and allows large masses to be moved, such as that of the screen, at various frequencies and abides by the very strict automobile constraints which are a low cost, a good resistance to substantial temperature variations and ease of implementation.

The haptic feedback module 4 is configured to cause the touch-sensitive surface 2 to vibrate in response to a contact with the touch-sensitive surface 2 in such a way that the generated vibration of the touch-sensitive surface 2 moves the touch-sensitive surface 2 by an amount of movement dR of between 5 and 110 μm (FIG. 1) with an acceleration of the movement of the touch-sensitive surface 2 of between 2*G and 8*G, where G corresponds approximately to 9.8 m/s².

The inventors have in fact discovered that, for automobile driving, haptic feedback is better perceived by the user if the sensation is close to that of a manipulation of a conventional push-button. Since the manipulation of a conventional push-button requires a depression generally in the region of more than one millimeter, the inventors have noted that by controlling, on the one hand, the acceleration values of the touch-sensitive surface 2 and, on the other hand, the amounts of the movement of the touch-sensitive surface 2, the sensed vibration gave the illusion of the manipulation of the physical button. It is in fact the modification of these two physical parameters of vibratory feedback, between 5 and 100 μm for the movements of the touch-sensitive surface 2, and between 2*G and 8*G for the acceleration of the movement of the touch-sensitive surface 2 which are the most relevant for affecting the sensation of users, allowing the vibratory feedback to be perceived as a button and thus to be better discriminated by the user while driving.

In the operating range for which the amount of movement is between 5 and 110 μm and the acceleration of the movement is between 2*G and 8*G, two subranges can be more precisely defined.

It is provided, for example, that the haptic feedback module 4 is configured to generate amounts of movements of the touch-sensitive surface 2 of between 5 and 38 μm for an acceleration of the touch-sensitive surface of between 4.5*G and 8*G.

It can also be provided that the haptic feedback module 4 is configured to generate amounts of between 54 and 110 μm for an acceleration of the movement of the touch-sensitive surface 2 of between 2*G and 4.5*G.

According to one example embodiment, the haptic feedback module 4 is configured to generate amounts of movements of the touch-sensitive surface 2 of between 5 and 38 μm for an acceleration of the touch-sensitive surface of between 4.5*G and 8*G and between 54 and 110 μm for an acceleration of the movement of the touch-sensitive surface 2 of between 2*G and 4.5*G.

Thus, according to the type of function selected by the user, it is possible to generate a haptic feedback which is distinct, but of which the amount and the acceleration of the movement remain within one of the two subranges.

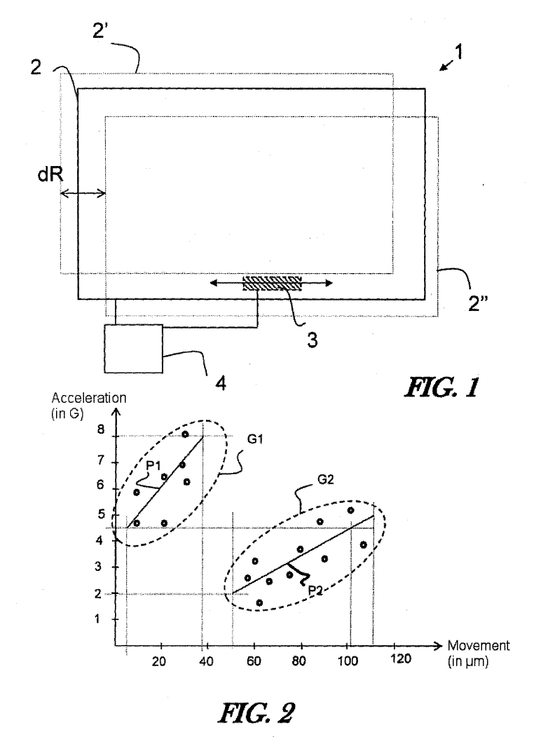

FIG. 2 thus shows schematically two groups of points G1, G2.

A first group of points G1 represents the first subrange for which the amount of movement of the touch-sensitive surface 2 is between 5 and 38 μm and the acceleration of the touch-sensitive surface is between 4.5*G and 8*G. A second group of points G2 represents the second subrange for which the amounts of the movement are between 54 and 110 μm for an acceleration of the movement of the touch-sensitive surface 2 of between 2*G and 4.5*G.

According to one example embodiment, the amount values of movements of the touch-sensitive surface and the corresponding acceleration values of the movement of the touch-sensitive surface form at least one group of points having an elliptical shape. The elliptical shape extends, for example, approximately along the diagonal of the operating range for which the amount of movement is between 5 and 110 μm and the acceleration of the movement is between 2*G and 8*G.

In the example shown in FIG. 2, the amount values of movements of the touch-sensitive surface and the corresponding acceleration values of the movement of the touch-sensitive surface form two groups of points G1, G2, the respective shape of which is elliptical, extending approximately along the diagonal P1, P2 of the respective subrange.

Moreover, it can be provided that the amount of movement of the touch-sensitive surface and the acceleration of the movement of the touch-sensitive surface have interdependent values, i.e. the determination of one entails the determination of the other.

For example, the increase in the value of the amount of movement of the touch-sensitive surface is approximately proportional to the increase in the value of the acceleration of the movement of the touch-sensitive surface.

The choice of the acceleration of the touch-sensitive surface as a function of the amount of the movements of the touch-sensitive surface and vice versa allows the haptic feedback sensation to be improved.

More precisely, the correspondence between the choice of the amount of the movements of the touch-sensitive surface 2 and the choice of the acceleration values allows the resemblance with a conventional push-button to be refined. It is in fact noted that an average amount of movement of between 54 and 110 μm is better perceived and discriminated if it is associated with low acceleration of between 2 and 4.5*G (P2 in FIG. 2). Conversely, a small amount of movement of between 5 and 38 μm is better perceived and discriminated if it is associated with an average acceleration of between 4.5*G and 8*G (P1 in FIG. 2).

Thus, in order to approximate the “push-button sensation”, the acceleration value must be increased with the increase in the amount of movement for small movements (less than 38 μm). For greater amounts of movement, beyond 54 μm, the acceleration is also increased with the increase in the movement, but at lower values than for small movements.

According to one example embodiment, the duration of the vibration of the touch-sensitive surface 2 is short, i.e. less than 200 ms, and preferably between 70 and 200 ms, such as between 110 and 140 ms. Short signals are in fact better perceived in these ranges of movement and acceleration of the movement of the touch-sensitive surface 2. The frequency of the vibration of the touch-sensitive surface 2 is, for example, between 60 and 200 Hz, such as 120 Hz.

1. A control device for a motor vehicle, comprising:
a touch-sensitive surface; and
a haptic feedback module configured to cause the touch-sensitive surface to vibrate in response to a contact with the touch-sensitive surface,
wherein the generated vibration of the touch-sensitive surface is obtained by movements of the touch-sensitive surface having an amount (dR) of between 5 and 110 μm with an acceleration of the movement of the touch-sensitive surface of between 2*G and 8*G.

2. The control device as claimed in claim 1, wherein the haptic feedback module is configured to generate amounts (dR) of movements of the touch-sensitive surface:
of between 5 and 38 μm for an acceleration of the movement of the touch-sensitive surface of between 4.5*G and 8*G, and/or
between 54 and 110 μm for an acceleration of the movement of the touch-sensitive surface of between 2*G and 4.5*G.

3. The control device as claimed in claim 1, wherein the duration of the vibration of the touch-sensitive surface is less than 200 ms.

4. The control device as claimed in claim 1, wherein the frequency of the vibration of the touch-sensitive surface is between 60 and 200 Hz.

5. A method for controlling a control device for a motor vehicle as claimed in claim 1, the method comprising:
causing the touch-sensitive surface to vibrate in response to a contact with the touch-sensitive surface by moving the touch-sensitive surface by an amount of movement of between 5 and 110 μm with an acceleration of the movement of the touch-sensitive surface of between 2*G and 8*G.

6. The control method as claimed in claim 5, wherein amounts of movements of the touch-sensitive surface are generated:
of between 5 and 38 μm for an acceleration of the movement of the touch-sensitive surface of between 4.5*G and 8*G, and/or
of between 54 and 110 μfor an acceleration of the movement of the touch-sensitive surface of between 2*G and 4.5*G.

7. The control method as claimed in claim 5, wherein the amount of movement of the touch-sensitive surface and the acceleration of the movement of the touch-sensitive surface have interdependent values.

8. The control method as claimed in claim 5, wherein the increase in the value of the amount of movement of the touch-sensitive surface is approximately proportional to the increase in the value of the acceleration of the movement of the touch-sensitive surface.

9. The control method as claimed in claim 5, wherein the duration of the vibration of the touch-sensitive surface is less than 200 ms.

10. The control method as claimed in claim 5, wherein in that the frequency of the vibration of the touch-sensitive surface is between 60 and 200 Hz.
